(19) United States
(12) Patent Application Publication
(10) Pub. No.: US 2005/0099123 A1
(43) Pub. Date: May 12, 2005

(54) Sealing structure and plasma display panel employing the same

(76) Inventors: Po-Cheng Chen, Yonghe City (TW); Jiun-Han Wu, Sanchong City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/827,195

(22) Filed: Apr. 19, 2004

(30) Foreign Application Priority Data
Nov. 6, 2003 (TW) 92131028

(51) Int. Cl. H01J 17/49

(52) U.S. Cl. 313/582

(57) ABSTRACT

A sealing structure and a plasma display panel employing the same. A front plate, a rear plate, and a sealing layer are all provided. Sealing strength and reliability of the sealing structure are improved by the intended position and geometric shape of the sealing layer located between the front plate and the rear plate, thereby raising plasma display panel yield.

### BACKGROUND OF THE INVENTION

1. Field of the Invention

The present invention relates to a sealing structure, and more particularly to a sealing structure for a plasma display panel.

2. Description of the Related Art

Flat panel displays (FPD), such as liquid crystal displays (LCD), organic light emitting diodes (OLED) and plasma display panels (PDP), are rapidly replacing cathode ray tubes (CRT). Plasma display panels are self-emitting, highly luminous, provided wider viewing angle, and have a simpler fabrication process. Thus they are a popular choice for industry.

A PDP is a display device employing charges accumulated by electrode discharge. Due to a variety of advantages, such as large scale, high capacity and full-color capability, the PDP has become one of the most popular flat panels for various applications.

Typically, a front plate and a rear plate of a PDP are formed first. The front plate is thus inverted for mounting onto the rear plate. The two plates are then sealed together to form closed discharge cells. The tightness of the sealing process can affect the yield of subsequent processes that remove gases from, or inject gases into the PDP. Additionally, the sealing process may affect the isolation between each discharge cell.

FIG. 1 is a perspective view illustrating a conventional method for sealing a front plate 12 and a rear plate 14 of a PDP 10.

The PDP 10 includes the front plate 12, the rear plate 14 in parallel with the front plate 12, and a plurality of barrier ribs 16 on a predetermined area of the rear plate 14.

In the conventional method for sealing the two plates, a sealing frit 18 is formed and surrounds the barrier ribs 16 on the rear plate 14, and a corresponding sealing frit 18 is formed on the front plate 12. The front plate 12 and the rear plate 14 are affixed, and the sealing frits 18 temporarily bond to each other. The front plate 12 and the rear plate 14 are then placed into an oven and heated to 450° C., and the sealing frits 18 are melted to form a sealing layer. After cooling, the front plate 12 and the rear plate 14 are tightly bonded together.

The sealing strength of the PDP 10, however depends on the position and geometric shape of the sealing layer 18′ located between the front plate 12 and the back plate 14, referring to FIGS. 2a to 2c. If the sealing layer 18′ has an unsatisfactory geometric shape as shown in FIGS. 2a to 2c, it is probable that the PDP 0.10 will crack or separate during a subsequent thermal compression step due to the insufficient strength of the seal thereof, resulting in low yield.

Therefore, it is necessary to further modify the position and geometric shape of the sealing layer located between the two plates, in order to improve the sealing strength of a PDP.

### SUMMARY OF THE INVENTION

Accordingly, an object of the present invention is to provide a sealing structure for plasma display panel providing improved sealing strength between the front plate and the rear plate of the plasma display panel, with increased the sealing structure reliability.

Another object of the present invention is to provide a plasma display panel having the sealing structure according to the present invention. Sealing strength and reliability of the sealing structure are improved by the intended position and geometric shape of the sealing layer located between the front plate and the rear plate, thereby raising the production yield.

To achieve the above objects, according to the present invention, a sealing structure with a high sealing strength comprises a first plate, a second plate under and offset from the first plate, and a sealing layer located between the first surface and the second surface providing a seal therebetween, wherein the sealing layer comprises a first region contacting the first plate and a second region contacting the second plate. Particularly, the first region extends at least to an outer edge of the underside of the first plate, and the second region extends at least to a boundary corresponding to the outer edge of the first plate.

According to the present invention, the sealing layer can be formed to extend beyond a plane containing the outer edge and the boundary.

In the present invention, a plasma display panel comprises a first plate, a second plate under and offset from the first plate, and a sealing layer located between the first surface and the second surface for sealing the first plate and the second plate, wherein the sealing layer comprises a first region contacting the first plate and a second region contacting the second plate. Particularly, the first region extends at least to an outer edge of the underside of the first plate, and the second region extends at least to a boundary corresponding to the outer edge of the first plate. Furthermore, the first plate or the second plate acts a front plate of the plasma display panel and the other remaining plate as a rear plate of the plasma display panel.

According to the present invention, the sealing layer can be formed to extend beyond a plane containing the outer edge and the boundary.

A detailed description is given in the following embodiments with reference to the accompanying drawings.

### BRIEF DESCRIPTION OF THE DRAWINGS

The present invention can be more fully understood by reading the subsequent detailed description in conjunction with the examples and references made to the accompanying drawings, wherein:

FIG. 1 is a perspective view illustrating a method for sealing a front plate and a rear plate of a PDP according to the related art.

FIGS. 2a to 2c are cross sections of a conventional sealing structure of a PDP.

FIG. 3 is a cross section of a combination of a first plate and a second of the present invention.

FIGS. 4a to 7e are cross sections of the sealing structures according to the present invention.

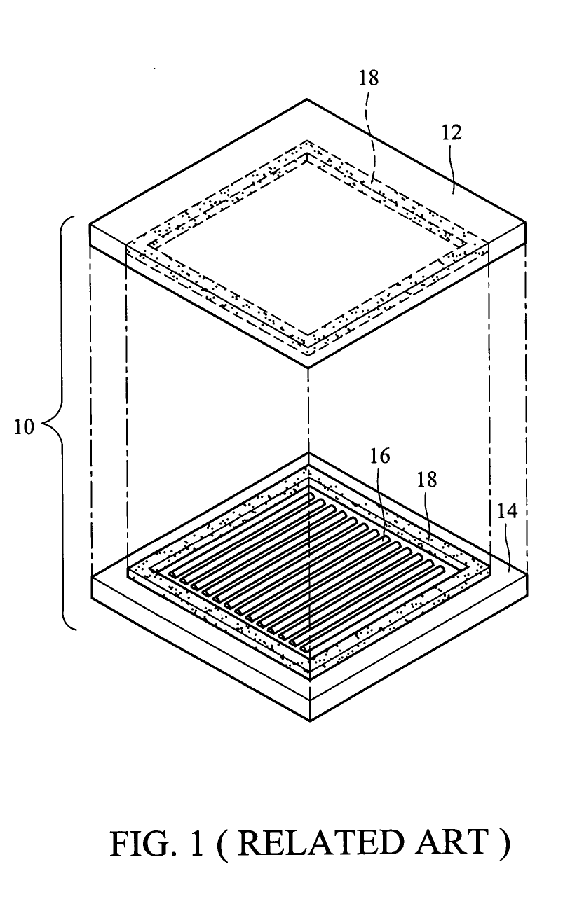

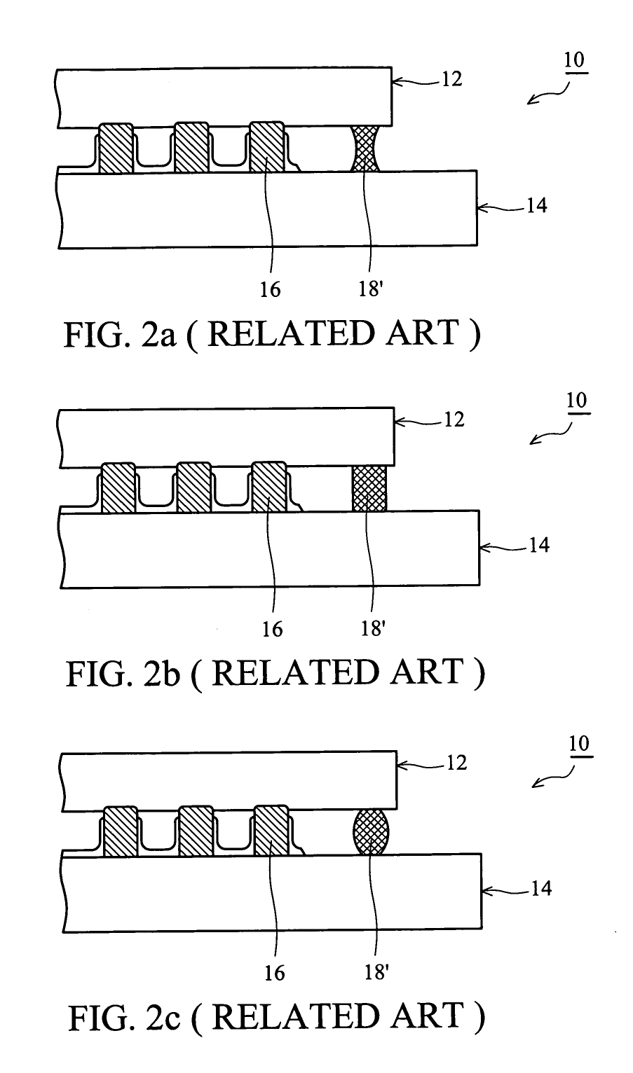

### DETAILED DESCRIPTION OF THE INVENTION

The present invention improves the sealing strength and reliability of a sealing structure through the specific position and geometric shape of the sealing layer thereof. While a PDP is used to illustrate the invention, numerous modifications and variations will be apparent to those skilled in the art.

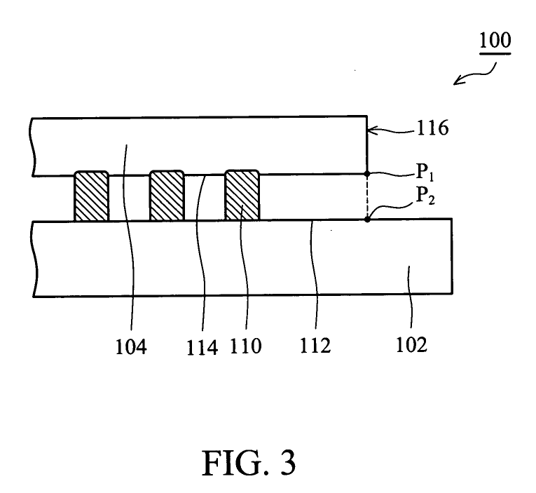

FIG. 3 is a cross section of a combination of a first plate and a second plate without a sealing layer, illustrating the positional relationship between each element of the sealing structure of a PDP. The PDP 100 comprises a first plate 104 and a second plate 102 parallel to and offset from the first plate 104, wherein the first plate 104 has a first surface 114 and the second plate 102 has a second surface 112 facing the first surface 114. A plurality of barrier ribs 110 are disposed between the two plates 104 and 102 for forming a discharging space. The first surface 114 of the first plate 104 has an outer edge P1, and the second plate 102 extends to a perpendicular plane containing the outer edge P1 of the first plate 104. Furthermore, the second plate 102 contains a boundary P2 corresponding to the outer edge P1 of the first plate 104, and a plane 122 containing the outer edge P1 and the boundary P2 is perpendicular to the second plate 102. The distance between the two plates 102 and 104 is about 50 μm to 250 μm.

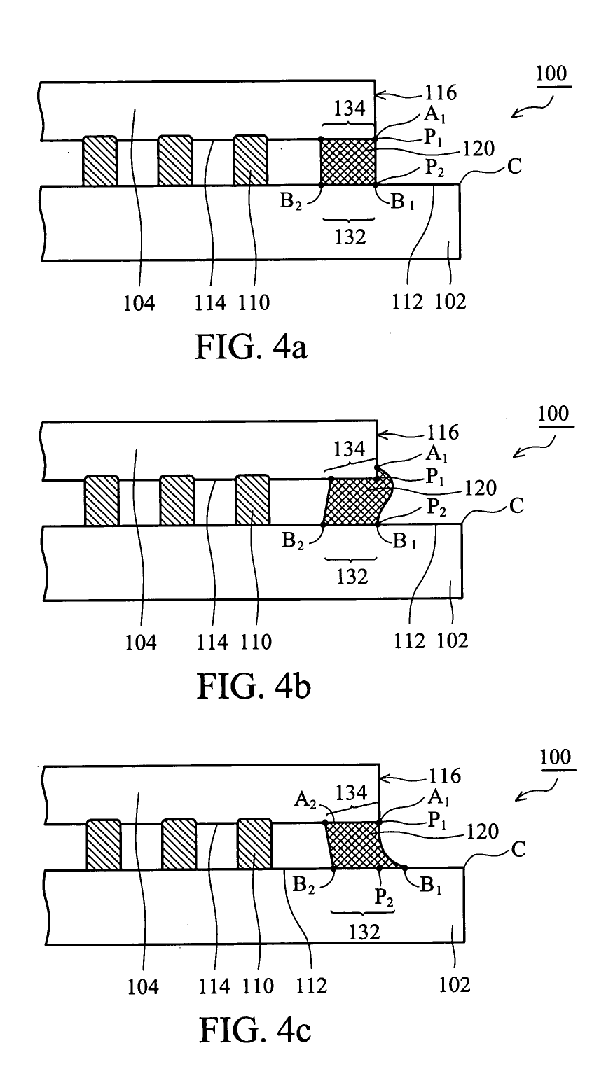

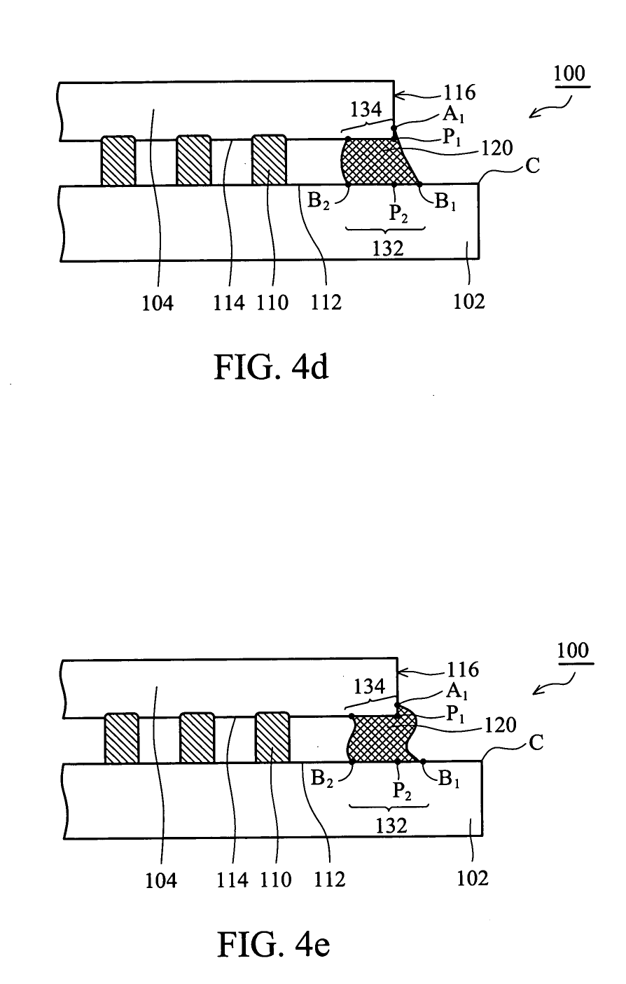

FIGS. 4a to 4e are cross sections illustrating sealing structures with a high sealing strength of the PDP according to the present invention.

Referring to FIG. 4a, the PDP 100 comprises a sealing layer 120 formed between the first plate 104 and the second plate 102 for sealing a peripheral region of the first plate 104 and the second plate 102, wherein the sealing layer 120 comprises a first region 134 contacting the first plate 104 and a second region 132 contacting the second plate 102. Moreover, the first region 134 contains a first edge A1 and the second region 132 contains a second edge B1 and a third edge B2, as shown in FIG. 4a. The first plate 104 or the second plate 102 acts a front plate of the plasma display panel and the other acts as a rear plate of the plasma display panel. The sealing layer 120 can be a sealing frit or an adhesive. Specifically, the position and geometric shape of the sealing layer 120, located between the two plates 102 and 104, according to the present invention is defined in the following.

The first region 134 of the sealing layer 120 extends at least to an outer edge P1 of the first surface 114, and the second region 132 of the sealing layer 120 extends at least to a boundary P2 corresponding to the outer edge P1. Moreover, the sealing layer 120 can be formed to extend beyond the plane 122 containing the outer edge P1 of the first surface 114 and the boundary P2, as shown in FIGS. 4b to 4e. Furthermore, the vertical distance between the first edge A1 and the second edge B1 is not less than the distance between the outer edge P1 and the boundary P2, and the horizontal distance between the second edge B1 and the third edge B2 is not less than the distance between the boundary P2 and the third edge B2. Accordingly, the vertical distance between the first edge A1 and the second edge B1 can be equal to the distance between the outer edge P1 and the boundary P2, as shown in FIGS. 4a and 4c. Additionally, the vertical distance between the first edge A1 and the second edge B1 can be more than the distance between the outer edge P1 and the boundary P2, as shown in FIGS. 4b, 4d and 4e.

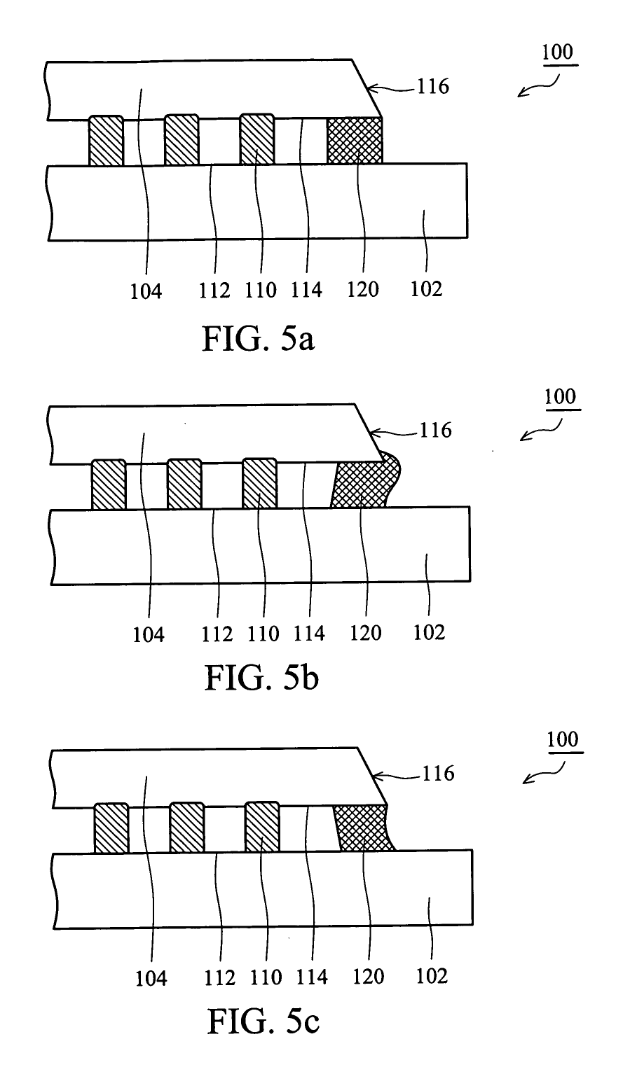

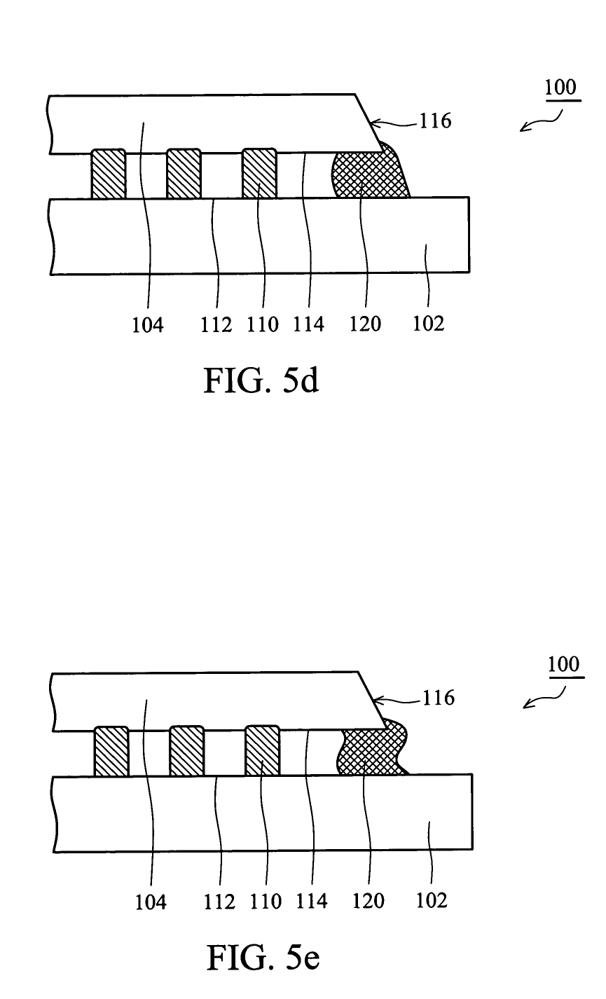

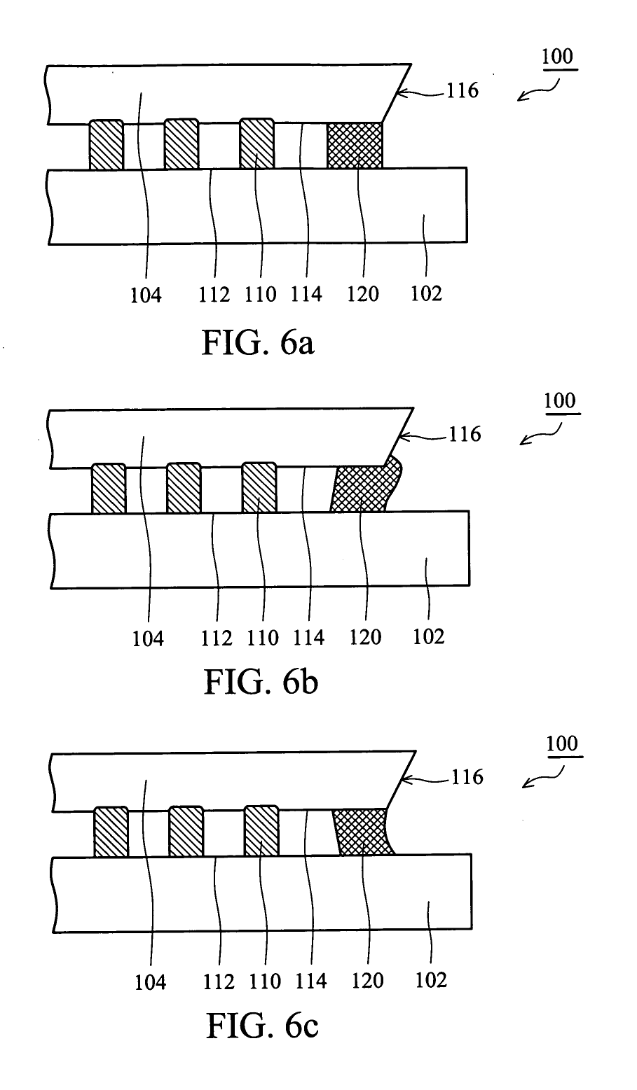

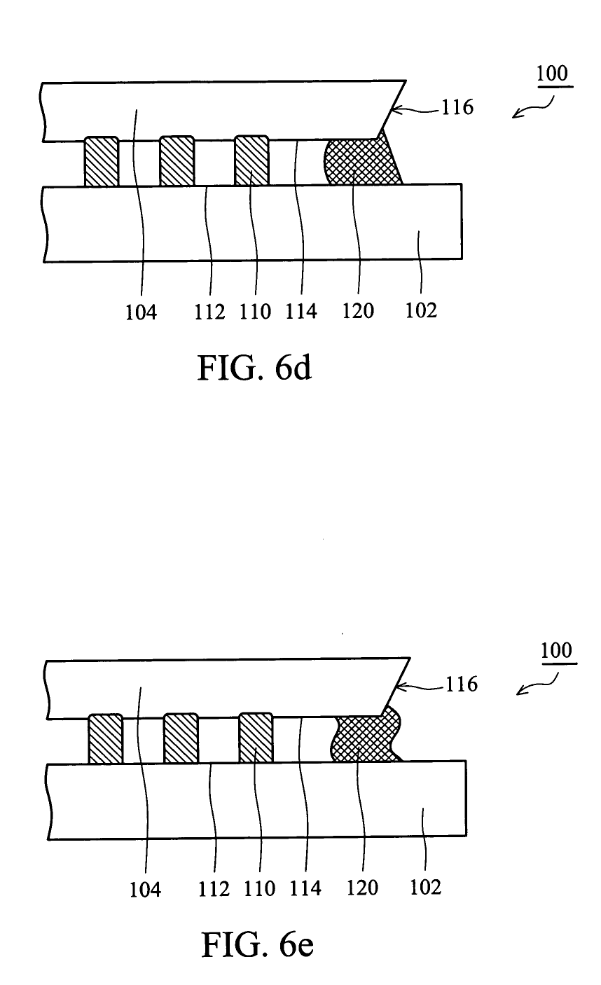

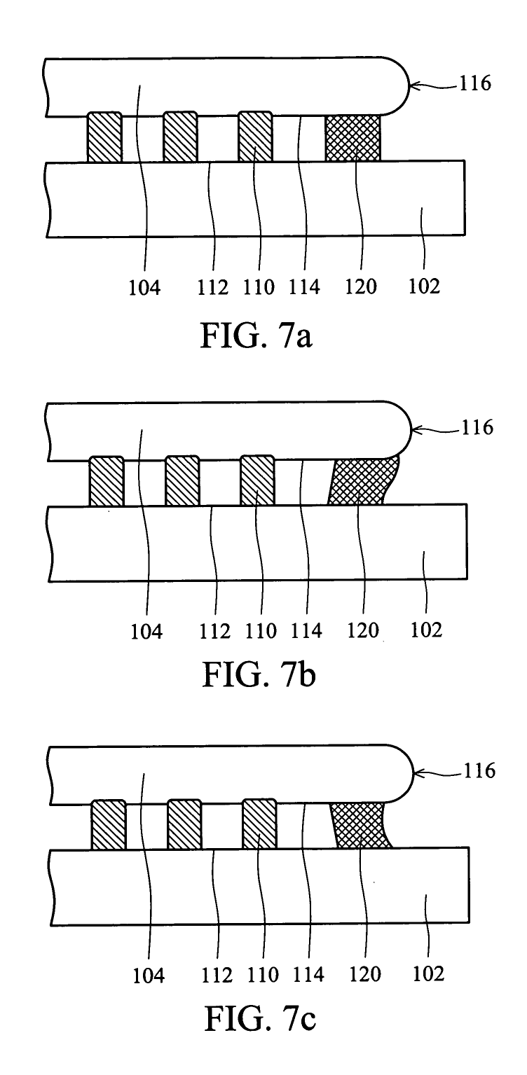

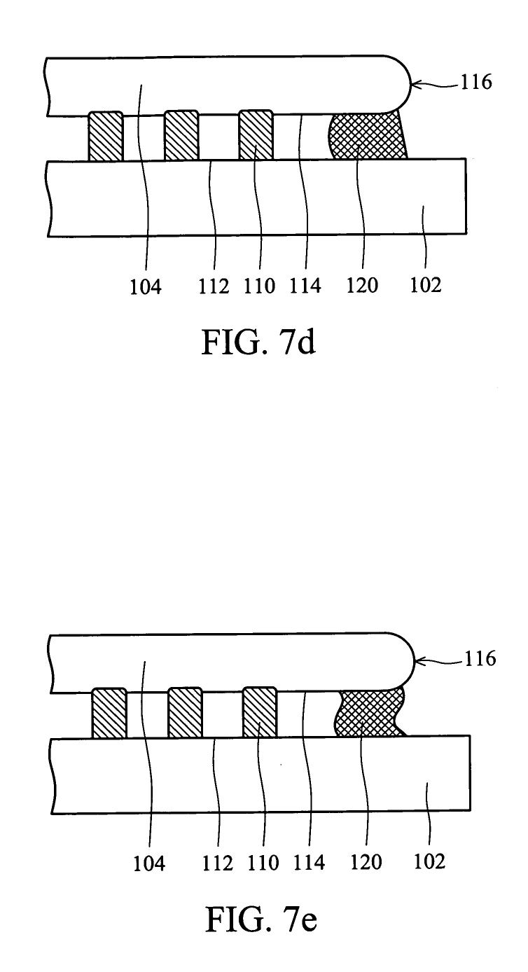

In the PDP 100 of the present invention, the peripheral side surface 116 of the first plate 104 can be planar and perpendicular to the first surface 114, as shown in FIGS. 4a to 4e. In another aspect, the peripheral side surface 116 of the first plate 104 can intersect with the first surface 114 to form an acute angle, as shown in FIGS. 5a to 5e. In still another aspect, the peripheral side surface 116 of the first plate 104 can intersect with the first surface 114 to form an obtuse angle, as shown in FIGS. 6a to 6e. The peripheral side surface 116 of the first plate 104 can also be a cambered surface as shown in FIGS. 7a to 7e, or a curved surface.

The thermal compression yields of conventional PDPs and the PDPs according to the present invention are respectively shown in Table 1. Accordingly, the crack loss of conventional PDPs is more than 30%. To the contrary, the crack loss of the sealing structure according to the present invention is less than 0.1%. Therefore, the sealing strength thereof is improved.

TABLE 1

| | | | Yield | Crack |
|---|---|---|---|---|
| | Sealing structure | | (%) | loss (%) |
| Conventional | \overline{B1B2} < \overline{P2B2} | H2 = H1 | 60% | 40% |
| PDPs | \overline{B1B2} < \overline{P2B2} | H2 > H1 | 70% | 30% |
| PDPs of the | \overline{B1B2} ≧ \overline{P2B2} | H2 ≧ H1 | 99.9% | 0.01% |
| present | | | | |
| invention | | | | |

\overline{B1B2}: horizontal distance between B1 and B2;
\overline{P2B2}: horizontal distance between P2 and B2;
H1: vertical distance between P1 and P2; and
H2: vertical distance between A1 and P2.

Accordingly, the sealing structure of the present invention provides improved sealing strength and increased reliability, when compared to the related art.

Moreover, the sealing structure is suitable not only for PDPs, but also for other FPDs such as OLEDs or LCDs is eliminating instability resulting from glass crack or separation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A sealing structure with improved sealing strength, comprising:
a first plate;
a second plate under and offset from the first plate; and
a sealing layer located between the first and second plate providing a seal therebetween, and further comprising a first region contacting the first plate and a second region contacting the second plate, wherein the first region extends at least to an outer edge of the underside of the first plate, and the second region extends at least to a boundary corresponding to the outer edge of the first plate.

2. The sealing structure as claimed in claim 1, wherein the distance between the first plate and the second plate is 50˜250 μm.

3. The sealing structure as claimed in claim 1, wherein the first plate has a peripheral side surface and the peripheral side surface is planar.

4. The sealing structure as claimed in claim 3, wherein the peripheral side surface of the first plate is cambered.

5. The sealing structure as claimed in claim 1, wherein the material of the sealing layer comprises a glass frit.

6. The sealing structure as claimed in claim 1, wherein the material of the sealing layer comprises an adhesive.

7. The sealing structure as claimed in claim 1, wherein the first plate is transparent.

8. The sealing structure as claimed in claim 1, wherein the sealing layer is formed to extend beyond a plane containing the outer edge and the boundary.

9. A plasma display panel, comprising:
a first plate;
a second plate under and offset from the first plate, wherein the first plate or the second plate acts a front plate of the plasma display panel and the other acts as a rear plate of the plasma display panel; and
a sealing layer located between the first and second plate providing a seal therebetween, and further comprising a first region contacting the first plate and a second region contacting the second plate, wherein the first region extends at least to an outer edge of the underside of the first plate, and the second region extends at least to a boundary corresponding to the outer edge of the first plate.

10. The plasma display panel as claimed in claim 9, wherein the distance between the first plate and the second plate is 50˜250 μm.

11. The plasma display panel as claimed in claim 9, wherein the first plate has a peripheral side surface and the peripheral side surface is planar.

12. The plasma display panel as claimed in claim 11, wherein the peripheral side surface of the first plate is cambered.

13. The plasma display panel as claimed in claim 9, wherein the material of the sealing layer comprises a glass frit.

14. The plasma display panel as claimed in claim 9, wherein the material of the sealing layer comprises an adhesive.

15. The plasma display panel as claimed in claim 9, wherein the sealing layer is formed to extend beyond a plane containing the outer edge and the boundary.

16. The flat plane display as claimed in claim 9, wherein the first plate is transparent.
